(19) United States
(12) Patent Application Publication
(10) Pub. No.: US 2008/0250264 A1
(43) Pub. Date: Oct. 9, 2008

(54) System for Adaptive Action Plan Compilation Based on Error Reporting

(76) Inventors: Andrew G. Hourselt, Tucson, AZ (US); Stefan Lehmann, Tucson, AZ (US); John T. Olson, Tucson, AZ (US); Steve P. Wallace, Casa Grande, AZ (US)

Correspondence Address: HAMILTON & TERRILE, LLP;IBM Tucson, P.O. BOX 203518, AUSTIN, TX, 78720, US

(21) Appl. No.: 11/695,675

(22) Filed: Apr. 3, 2007

(51) Int. Cl. G06F 11/07

(52) U.S. Cl. 714/2

(57) ABSTRACT

A database of action plans carried out by a service provider is provided that stores the action plan as a series of action codes as well as the associated information such as error code, error type and whether the action plan resolved the problem. When an error occurs and is reported automatically, the database is searched for the error that occurred. Action plans as well as success rates are collected with most probable solutions being presented first. Each action code in the action plan corresponds to a particular point in maintenance documentation that is stored, e.g., on a management console, at the customer location. After reporting the error, the management console receives action plans for the error based on actual service reports as well as action plans suggested by documentation. When a service representative accesses the management console for information about the error, appropriate documentation is presented for each step in the action plan, allowing the service representative to follow along the suggested action plans and associated maintenance documentation onsite.

### BACKGROUND OF THE INVENTION

1. Field of the Invention

The present invention relates to product support management and more particularly to reporting product problem solutions and still more particularly to adaptive action plan compilation based on error reporting.

2. Description of the Related Art

Corporations maintain customer service organizations to address customer problems with products to insure customer product satisfaction. Typically customers are provided a number to call or an e-mail address to contact if they should have questions about or, encounter problems with, products. As each problem is reported, the problem is assigned a problem report reference number for tracking progress towards problem resolution, both by customers and by the customer service organization. Once a problem is reported and a problem record reference number is assigned, a Customer Service Representative (CSR) is assigned the responsibility of finding a solution to the particular problem. Once the problem is resolved, the CSR reports the steps or actions to resolve the problem to the customer service organization and the report is logged to close the problem reference number. Many customer service organizations use shorthand type of codes to improve reporting efficiency and reduce valuable CSR time spent reporting problem resolutions.

For example, it is known for CSRs to use hardcopy lists of shorthand codes or acronyms, such as Technical Area Codes (TAC), to encode and decipher problems and resolutions for each particular problem. Typically, the CSR carries hardcopy volumes of these TACs along on a service call and refers to those volumes when completing a service report. However, maintaining these lists and continually printing and distributing updated hard copies can be inconvenient and costly. Further, with each newly added or deleted code, these volumes become out of date. To address this issue, it is known for a CSR to provide feedback on-line, recorded in, e.g., a 60-80 character field as a Quality Service Activity Report (QSAR). A typical QSAR does not provide much information, much less detailed information on actions the CSR has taken to resolve a given problem. Often several different customers encounter very similar problems or identically described problems may occur repeatedly with the same system, subsystem or subassembly. Known QSARs do not allow the CSR describe to the subtle variations on resolutions to these similar problems.

With the typically large volume of problem reports it may be impractical to have each CSR report each problem individually. Also, a typical QSAR provides very limited information. So, the same detailed information may be recollected each time the same or a slightly different variation on the same problem occurs. Sifting and collating problem reports to reduce them to a more manageable number can be a daunting task. Adding problem reports as the information is being sifted further exacerbates this problem. Furthermore, technology is changing so rapidly today that problem codes may be directed at stale problems or obsolete solutions. Consequently, customer service organizations expend considerable energy and company resources collecting and maintaining adequate problem report documentation.

One field in which customer service can be an issue is the data storage field. It is known to use high density, removable media storage libraries within a data storage system to provide large quantities of storage in networked computer systems. Typically, such data storage systems are employed for backup or other secondary storage purposes, but the data storage system may also be used as primary storage in circumstances that are conducive to sequential data access and the like. Often the data is stored on media cartridges, such as magnetic tapes or optical disks, which are arranged in storage bins and accessed when data on a cartridge is requested. Known media cartridges are capable of storing large quantities of data. A storage system may include a plurality of legacy storage devices (i.e., devices which are not specifically designed to work with a more current data storage system.)

One example of a data storage system is a virtual tape server (VTS) system. A VTS system links a plurality of storage devices, both current storage devices and legacy storage devices. Each of these storage devices may be considered a separate component or subsystem. A typical VTS system includes a virtual tape server and an automated media library. In addition to the storage devices the VTS system can include a plurality of consoles for performing various tasks. The library is controlled by a library manager that is similar to a workstation computer. One known console used within a VTS system is a management and error monitoring console.

It is known for storage systems and other computer systems in the field to generate alerts when severe errors occur. What error occurred as well as associated data are sent for analysis and repair. Part of this analysis and repair includes looking up action plans in product documentation which takes service time to collect to come up with a plan for fixing the problem. An issue relating to this process is that much time may be spent generating a list of actions and not enough information is immediately available regarding what actions have been successful at fixing certain types of problems. To address this issue, the experience of the service representatives involved is relied upon as well as manual research that can take hours, days or even longer when a customer's problem must be fixed as soon as possible.

### SUMMARY OF THE INVENTION

In accordance with the present invention, a database of action plans carried out by a service provider is provided that stores the action plan as a series of action codes as well as the associated information such as error code, error type and whether the action plan resolved the problem. When an error occurs and is reported automatically, the database is searched for the error that occurred. Action plans as well as success rates are collected with most probable solutions being presented first. Each action code in the action plan corresponds to a particular point in maintenance documentation that is stored, e.g., on a management console, at the customer location. After reporting the error, the management console receives action plans for the error based on actual service reports as well as action plans suggested by documentation. When a service representative accesses the management console for information about the error, appropriate documentation is presented for each step in the action plan, allowing the service representative to follow along the suggested action plans and associated maintenance documentation onsite.

More specifically, in one embodiment, the invention relates to a computer-implementable method for resolving errors. The method includes storing a plurality of actions plans within a database, each of the action plans including an associated success rate for resolving an error; searching the database for the error; presenting a group of action plans that correspond to the error, the action plans being presented based upon the success rates for resolving the error; and, selecting an action plan from the group of action plans being presented.

In another embodiment, the invention relates to a system which includes a processor, a data bus coupled to the processor and a computer-usable medium embodying computer program code. The computer-usable medium is coupled to the data bus and comprises instructions executable by the processor and configured for storing a plurality of actions plans within a database, each of the action plans including an associated success rate for resolving an error; searching the database for the error; presenting a group of action plans that correspond to the error, the action plans being presented based upon the success rates for resolving the error; and, selecting an action plan from the group of action plans being presented.

In another embodiment, the invention relates to a computer-usable medium embodying computer program code. The computer program code comprising computer executable instructions configured for storing a plurality of actions plans within a database, each of the action plans including an associated success rate for resolving an error; searching the database for the error; presenting a group of action plans that correspond to the error, the action plans being presented based upon the success rates for resolving the error; and, selecting an action plan from the group of action plans being presented.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 shows a block diagram of a product service reporting system;

FIG. 2 shows a block diagram of hierarchically searching service code records to find and return an appropriate service code

FIG. 3 shows a schematic block diagram illustrating a representative virtual tape server system which incorporates a product service reporting function;

FIG. 4 shows a flow chart of the operation of the customer service reporting system; and

FIG. 5 shows a flow chart of the operation of generating a final list of service reports.

### DETAILED DESCRIPTION

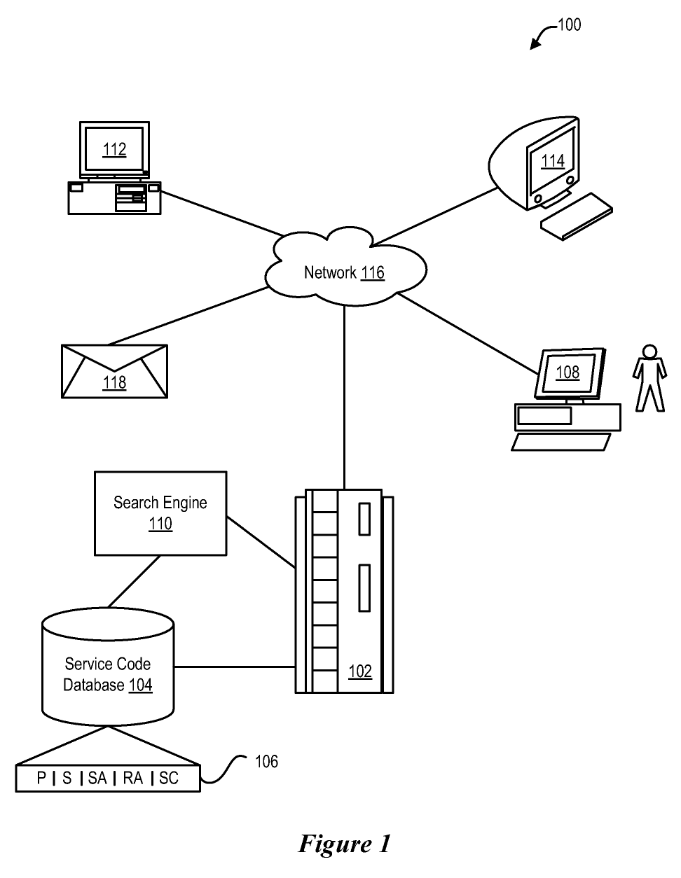

FIG. 1 shows an example of a product service reporting system 100 (also referred to as a customer service reporting system). The product service reporting system 100 may provide customer service support for reporting solutions to problems for any typical system, subsystem and subassembly, such as an IBM 3494 Tape Library Dataserver (IBM 3494). The product service reporting system 100 may include a service appliance, server (102 in this example) or service communications tool that may be centrally located or distributed amongst a number of remotely connected devices. A service code database 104 located on the server 102, for example, stores service code records 106 of solutions to previously encountered product problems. Service code records 106 may be generated through a service code GUI that may be available at a product management terminal 108 located with the server 102, or remotely located, e.g., at a customer service office. Each service code record 106 may include, for example, Product identification (P), Subsystem identification (S), Subassembly identification (SA), Repair Action (RA) and an associated Service Code (SC).

A search engine 110 may be included to facilitate quickly searching hierarchically through the service code database 104. Remotely located customer service terminals 112 include a graphical user interface (GUI) to provide Customer Service Representatives (CSRs) with access to the product service reporting system 100. Optionally, one or more customer service units (CSU) 114 are available for customer access to the product service reporting system 100. In this example, the product management terminal 108, customer service terminals 112 and customer service units 114 are connected to the product service reporting system 100 over a network such as the Internet 116. Also, a manufacturer update facility (e.g., an automatic e-mail generation facility) 118 may be provided to notify the customer service organization, for example, of newly added or modified service code records 106.

So, a user (a customer or a CSR) can enter problem reports through one of the customer service terminals 112 or customer service units 114. Then, the user hierarchically searches the service code database 104 (e.g., using search engine 110) to select a record that specifically matches the problem how it was resolved. Preferably, the service code records 106 are sorted in ascending alphabetic order by field for quicker searching. Each service code record 106 may include a problem repair action (RA) of any length and detail. The repair action may be remotely updated (e.g., from the product management terminal 108) to improve problem isolation to a specific problem set. Further, service code database 104 updates may be distributed, e.g., e-mailed 118, and service codes may be returned (also e-mailed 118) as a service event.

Thus, it may be determined through data mining or otherwise that one service code is associated with a high number of reported part or non-parts activity requests on a given machine area. For example, an unusually high number of adjustments are being required to the accessor assembly in a mass storage system. This may indicate that that particular service code is too generic to provide problem tracking with sufficient specificity and that the service code covers a number of different related/unrelated problems. In response, the list of service codes or service code records 106 may be dynamically updated, interactively asking service personnel additional questions on the specific service action in real time to elicit responses that improve problem isolation. Thereafter, service codes may be quickly and automatically updated in all service appliances or servers worldwide, e.g., at local copies of the service code database 110. Thus, instead of relying on very limited information in QSAR data with multiple follow-up calls to service personnel (sometimes occurring weeks or months later) to obtain information with necessary specificity; the preferred embodiment product service reporting system 100 collects very specific and timely data seamlessly and nearly automatically.

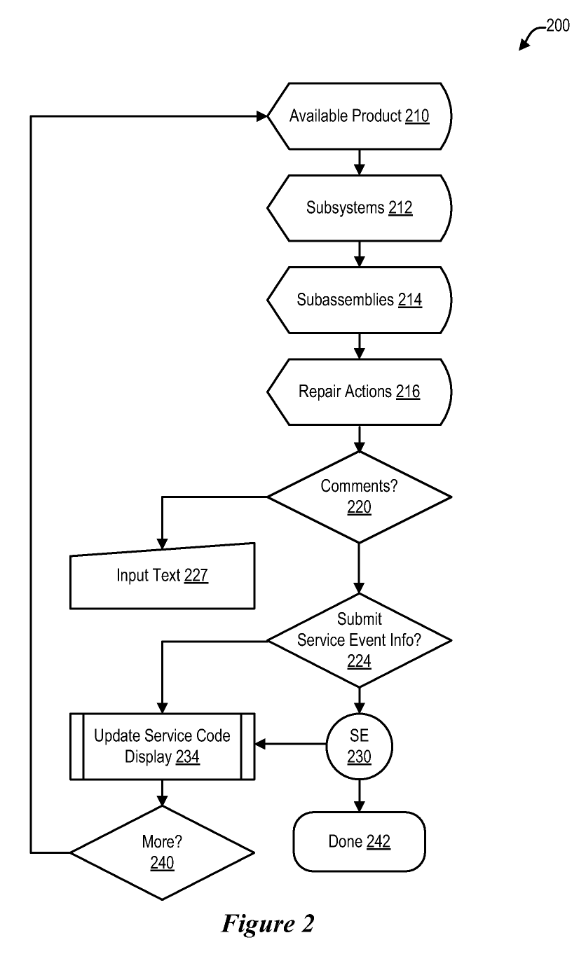

FIG. 2 shows an example of hierarchically searching 200 service code records (106 in FIG. 1) to find and return an appropriate service code according to a preferred embodiment of the present invention. First, in step 210 all unique product names are displayed (e.g., at a CSU 114) and one product is selected. Then, in step 212 a list of unique subsystem names are displayed for the selected product and one subsystem is selected. In step 214 all unique subassemblies are displayed for the selected subsystem, and one subassembly is selected. Next, in step 216, list of recognized repair actions for the selected subassembly are displayed and one repair action is selected.

A service code is generated as a result of selecting a specific repair action, and if desired in step 220, comments 222 may be added to the service code describing the service performed. Once comments have been added in step 222 or if in step 220 it is decided not to enter comments, in step 224 the selected information may be submitted as a service event 230. Once the service event is submitted in step 230 or canceled in step 224, in step 234 the service code data may be updated automatically on the service appliance or server 102 using any suitable method. Then, in step 240 if additional problem solutions remain to be reported, returning to step 210 another/the same product may be selected and another appropriate service code generated. Once all problems have been addressed in step 240, the search is complete 242.

Thus, advantageously, instead of relying on very limited information in QSAR data or being plagued with multiple costly follow up calls to service personnel to obtain service information; the product service reporting system 100 collects timely service data and, seamlessly and nearly automatically, provides service personnel with specifically tailored and descriptive service codes. The product service reporting system minimizes or nearly eliminates field reporting delays and especially expensive follow up calls that previously occurred only well after the problem details have been forgotten. Since the CSR can enter the data and update service codes on the fly and in real time in a preferred embodiment system, database updates take place immediately rather than weeks or months after the problem.

Additionally, the service code activity may be monitored and service codes updated in response to elicit more specific feedback information from the field. Thus, persistent problems can be isolated and eliminated. Service information can be synchronized for all connected machines, worldwide and the collected information may be seamlessly and automatically returned to the customer service organization.

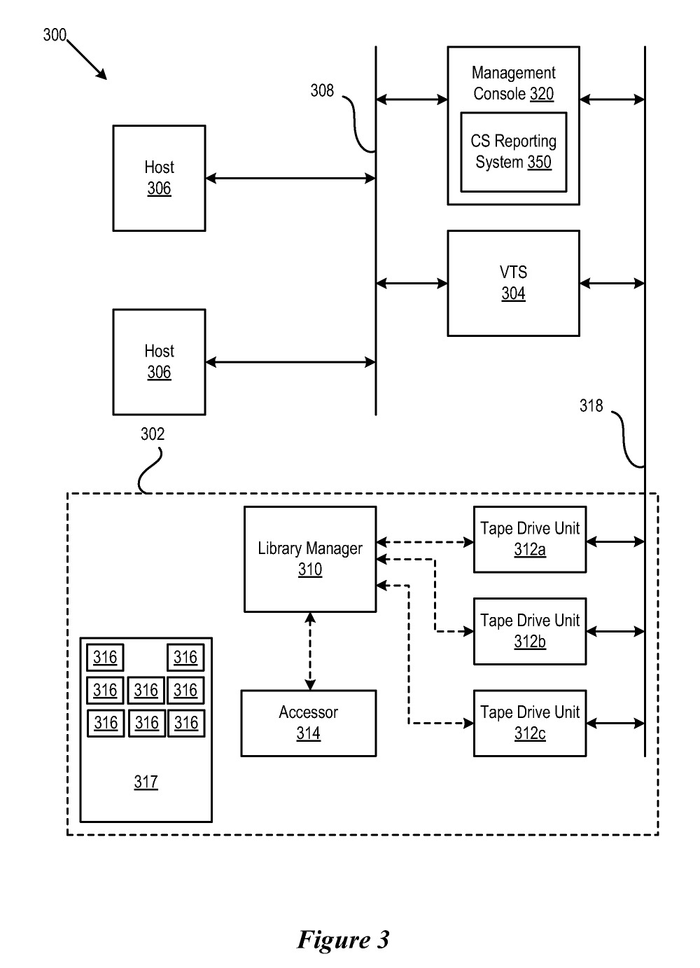

FIG. 3 illustrates a schematic block diagram of a representative virtual tape system 300 which incorporates a product service reporting function. The system 300 includes at least one automated library unit 302, at least one virtual tape server 304, and at least one host 306. Each host 306 may be a mainframe computer. Alternatively, the host 306 may be a server or personal computer using a variety of operating systems. The host 306 and the virtual tape server 304 are connected via a storage area network (SAN) 308 or similar communications channel.

The automated tape library unit 302 includes a library manager 310, one or more data drive devices, which may be tape drive units 312, an accessor 314, and a plurality of media cartridges 316. The plurality of media cartridges 316 may be stored in one or more media cartridge storage bins 317.

The system 300 also includes a management console 320. The management console 320 may be a server or personal computer using a variety of operating systems. The management console 320 includes a customer service reporting system 350.

The library manager 310 is interconnected with, and controls the actions of, the tape drive units 312 and the accessor 314. The library manager 310 typically also includes one or more hard disk drives (not shown) for memory storage, as well as a control panel or keyboard (not shown) to provide user input. The control panel may be a computer in communication with the library manager 310 so that a user can control the operating parameters of the automated tape library unit 302 independently of the host 306.

The automated tape library unit 302 is shown with three tape drive units 312a, 312b, and 312c. The present invention is operable with one or any larger number of tape drive units 312. The tape drive units 312 may share one single repository of cartridges 316. Alternatively, the tape drive units 312 may independently correspond to and utilize multiple repositories of cartridges 316. The tape drive units 312 may be distributed over multiple locations to decrease the probability that multiple tape drive units 312 will be incapacitated by a disaster in one location.

The interconnections between the library manager 310, the tape drive units 312, and the accessor 314 are shown as dashed lines to indicate that the library manager 310 transmits and receives control signals, rather than data to be stored or retrieved, to the tape drive units 312 and/or the accessor 314. Data for storage or retrieval may instead be transmitted directly between the virtual tape server 304 and the tape drive units 312 via a network 318, which may be a storage area network (SAN), a local area network (LAN), a wide area network (WAN), or a different type of network, such as the Internet or a direct connection between the virtual tape server 304 and the tape drive devices 312.

The accessor 314 may be a robotic arm or other mechanical device configured to transport a selected cartridge 316 between a storage bin and a tape drive unit 312. The accessor 314 typically includes a cartridge gripper and a bar code scanner (not shown), or similar read system, mounted on the gripper. The bar code scanner is used to read a volume serial number (VOLSER) printed on a cartridge label affixed to the cartridge 312. The tape drive units 312 may be replaced by optical disk drives or other magnetic drives. Similarly, the cartridges 316 may contain magnetic media, optical media, or any other removable media corresponding to the type of drive employed.

The management console 320 includes a customer service reporting system 350. The customer service reporting system 350 includes a database of action plans carried out by a service provider. The database stores the action plan as a series of action codes as well as the associated information such as error code, error type and whether the action plan resolved the problem. When an error occurs and is reported automatically, the database is searched for the error that occurred. Action plans as well as success rates are collected with most probable solutions being presented first. Each action code in the action plan corresponds to a particular point in maintenance documentation that is stored within the management console 320. After reporting the error, the management console 320 receives action plans for the error based on actual service reports as well as action plans suggested by documentation. When a service representative accesses the management console 320 for information about the error, appropriate documentation is presented for each step in the action plan, allowing the service representative to follow along the suggested action plans and associated maintenance documentation onsite.

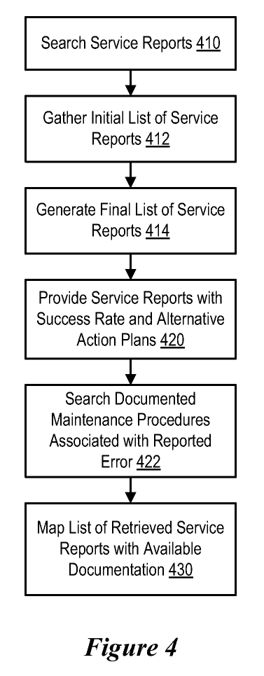

Referring to FIG. 4, a flow chart of the operation of the customer service reporting system 100 is shown. Each service report submitted by a service user at the end of a service call contains the error codes reported in the problem report, the error code that initiated the report, for the problem being serviced, a list of actions and comments and whether the report was ultimately successful (e.g., svc_report = error_reported, {error_list}, {(a_{—}0, <comments>), (a_{—}1, <comments>), . . . , (a_n, <comments>)}, success=<true|false>). In certain embodiment, the service report may also include logging information such as timestamp, user name, etc.

The action codes (a_{—}0, . . . ) are stored in an index that is dynamically updated as part of the customer service reporting system 350 on the management console 320. The index contains a mapping of the action code to a system, subsystem, component and action, as well as a pointer to maintenance documentation that covers the action.

The database receives error data in the event that a problem is reported automatically. The database automatically searches for service reports that contain the reported error at step 410. An initial list of service reports is gathered before the reports are all compared together at step 412. The database includes a success rate variable (success_rate) that added to each service report object (svc_report) to store the success rate of an action plan before a final list of service reports is generated.

Next, a final list of service reports is generated by the customer service reporting system 350 at step 414. The final list of service reports is presented at step 420. The resulting svc_report objects have a success rate and list of alternative action plans, such as:

svc_report = 80B4, {80B4, 80B4, 52EA, 000A, 52EA}, {1212, 0113, 0114, 3217}, success_rate=0.77, alternatives={(action_list_{—}1, merge_condition=“unnecessary_steps”, (action_list_{—}2, merge_condition=“different_order”), . . . }

Next, documented maintenance procedures for the reported error are searched at step 422. Documented action plans for the reported error are appended to the overall action plan, and it is returned to the management console after the problem is reported at step 430.

At the management console, a user logs in to access documentation and can view the reported problem in a problem log. When the problem is selected, the user can view the retrieved list of action plans that have been successful in fixing this problem. Each action is mapped to documentation available electronically (mapped via URL or other document location) and any action in an action plan can be selected to view associated maintenance procedures.

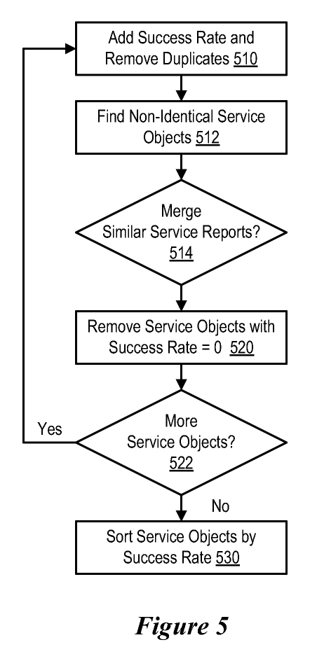

Referring to FIG. 5, a flow chart of the operation of generating a final list of service reports is shown. More specifically, when generating a final list of service reports, the customer service reporting system 100 adds the success rate of svc_report objects that are already identical and remove duplicates, leaving the most recently occurring service report objects at step 510.

For each svc_report object, find any non-identical svc_report objects for the same error code at step 512. If the size of the union of the actions performed is the same as the size of the longer svc_report, the system decides whether to merge the similar service reports at step 514. The customer service reporting system 100 applies one of a plurality of rules when determining whether to merge the service reports.

More specifically, if the longer service report has unnecessary steps, and both action sequences have successes and the length of the service report differs by no more than a certain threshold, such as three actions, then the system merges the two service reports as one action plan and considers the success rate across both. If the shorter service report is insufficient and then the shorter action sequence has no successes, then the system does not merge the service reports. If the shorter service report has been incorrectly reported and the length of the reports differs by greater than the threshold, such as five actions, but the shorter report has successes anyway, then the system does not merge the service reports. If the length of the service reports is equal, but the order of steps is different, then the system merges the service reports. If the size of the union of the service reports is greater than either svc_report, then the service reports contain exclusive actions and should be considered separately for success rate.

Merging of service reports is performed by adding the action plan of the service report to be merged with the service report as a list of alternatives, and noting which case was found, so that this can be presented to the user. For example, “The following action plans have also succeeded, and differ only in order of actions performed” or “The following action plans have also succeeded, but skip some steps found in this action plan”.

Next, any svc_report object where the success rate is zero is removed from the list at step 520. Next, the system determines whether there are any remaining service report objects to consider at step 522. If so, then the processing of this service report object continues at step 512. The remaining service report objects are sorted by success rate at step 530 and the operation completes execution.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while the preferred embodiment is described in conjunction with a VTS system, it will be appreciated that such a system can be used within any type of computer system in which it is desirable to provide error resolution.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for resolving errors comprising:
storing a plurality of actions plans within a database, each of the action plans including an associated success rate for resolving an error;
searching the database for the error;
presenting a group of action plans that correspond to the error, the action plans being presented based upon the success rates for resolving the error; and,
selecting an action plan from the group of action plans being presented.

2. The computer implementable method of claim 1, further comprising:
associating maintenance documentation with an error within the database; and,
presenting a link to associated maintenance documentation upon selection of the action plan from the group of action plans.

3. The computer implementable method of claim 1, further comprising:
associating maintenance documentation with an action code of an action plan within the database; and,
presenting a link to associated maintenance documentation upon selection of the action code.

4. The computer implementable method of claim 1, wherein:
the database is stored at a customer location and is remotely updated by a service provider.

5. The computer implementable method of claim 1, wherein:
the database is stored within a management console of a tape system.

6. The computer implementable method of claim 5, wherein:
the management console receives action plans for the error based on actual service reports as well as action plans suggested by documentation; and,
when a service representative accesses the management console for information about the error, appropriate documentation is presented for each step in the action plan, allowing the service representative to follow along the suggested action plans and associated maintenance documentation onsite.

7. A system comprising:
a processor;
a data bus coupled to the processor; and
a computer-usable medium embodying computer program code, the computer-usable medium being coupled to the data bus, the computer program code comprising instructions executable by the processor and configured for:
storing a plurality of actions plans within a database, each of the action plans including an associated success rate for resolving an error;
searching the database for the error;
presenting a group of action plans that correspond to the error, the action plans being presented based upon the success rates for resolving the error; and,
selecting an action plan from the group of action plans being presented.

8. The system of claim 7, wherein the instructions are further configured for:
associating maintenance documentation with an error within the database; and,
presenting a link to associated maintenance documentation upon selection of the action plan from the group of action plans.

9. The system of claim 7, wherein the instructions are further configured for:
associating maintenance documentation with an action code of an action plan within the database; and,
presenting a link to associated maintenance documentation upon selection of the action code.

10. The system of claim 7, wherein:
the database is stored at a customer location and is remotely updated by a service provider.

11. The system of claim 7, further comprising:
a management console; and wherein
the database is stored within the management console.

12. The system of claim 11, wherein:
the management console receives action plans for the error based on actual service reports as well as action plans suggested by documentation; and,
when a service representative accesses the management console for information about the error, appropriate documentation is presented for each step in the action plan, allowing the service representative to follow along the suggested action plans and associated maintenance documentation onsite.

13. A computer-usable medium embodying computer program code, the computer program code comprising computer executable instructions configured for:
storing a plurality of actions plans within a database, each of the action plans including an associated success rate for resolving an error;
searching the database for the error;
presenting a group of action plans that correspond to the error, the action plans being presented based upon the success rates for resolving the error; and,
selecting an action plan from the group of action plans being presented.

14. The computer-usable medium of claim 13, wherein the embodied computer program code further comprises computer executable instructions configured for:
associating maintenance documentation with an error within the database; and,
presenting a link to associated maintenance documentation upon selection of the action plan from the group of action plans.

15. The computer-usable medium of claim 13, wherein the embodied computer program code further comprises computer executable instructions configured for:
associating maintenance documentation with an action code of an action plan within the database; and,
presenting a link to associated maintenance documentation upon selection of the action code.

16. The computer-usable medium of claim 13, wherein:
the database is stored at a customer location and is remotely updated by a service provider.

17. The computer-usable medium of claim 13, wherein:
the database is stored within a management console of a tape system.

18. The computer-usable medium of claim 17, wherein:
the management console receives action plans for the error based on actual service reports as well as action plans suggested by documentation; and,
when a service representative accesses the management console for information about the error, appropriate documentation is presented for each step in the action plan, allowing the service representative to follow along the suggested action plans and associated maintenance documentation onsite.
